(19) United States
(12) Patent Application Publication
(10) Pub. No.: US 2004/0101653 A1
(43) Pub. Date: May 27, 2004

(54) Sheet-like element with customizing elements, for building-yard use and for delimiting spaces

(75) Inventors: Mario Beretta, Sirtori (IT); Paolo Molteni, Villa Raverio (IT)

Correspondence Address: MODIANO & ASSOCIATI, Via Meravigli, 16, MILANO, 20123, IT

(73) Assignee: TENAX S.p.A.

(21) Appl. No.: 10/716,547

(22) Filed: Nov. 20, 2003

(30) Foreign Application Priority Data
Nov. 21, 2002 (IT) MI2002A002474

(51) Int. Cl. B32B 3/06

(52) U.S. Cl. 428/101

(57) ABSTRACT

A sheet-like element with customizing elements, highlighting elements, reflective elements, lettering, characters and the like, particularly for building-yard use and for delimiting spaces, comprising a sheet-like body made of plastics that is longitudinally elongated, and comprising a tape provided with graphic markings, characters, designs and the like that is monolithically associated with said sheet-like body.

### BACKGROUND OF THE INVENTION

The present invention relates to a sheet-like element with customizing elements, highlighting elements, reflective elements, lettering, characters and the like particularly for building-yard use and for delimiting spaces.

As is known, spaces such as building yards and the like are currently delimited by using nets constituted by a sheet-like element made of plastics that is provided with a plurality of through openings of various sizes.

These kinds of net, which are normally produced by extrusion, also generally have strip-like regions that are continuous and free from holes, especially for example at the longitudinal edges.

With these kinds of nets, currently there are considerable difficulties if it is necessary to apply lettering, drawings, reflective elements, indications or the like, since it is practically impossible to perform printing operations on the net because they can be deleted easily; it is therefore necessary to resort to external elements, such as signs and the like, that must be supported proximate to the net.

Obviously, this approach causes considerable difficulties and requires the use of labor to position lettering and the like.

### SUMMARY OF THE INVENTION

The aim of the invention is to solve the problem noted above, by providing a sheet-like element with customizing elements, highlighting elements, reflective elements, lettering, characters and the like, particularly for building-yard use and for delimiting spaces, that allows to apply lettering, customization elements, designs, characters, reflective elements and the like directly onto the sheet-like element.

Within this aim, an object of the invention is to provide a sheet-like element that though having considerably improved characteristics, can be obtained with conventional technologies and without particular cost increases.

Another object of the present invention is to provide a sheet-like element that thanks to its particular constructive characteristics is capable of giving the greatest assurances of practicality, reliability and safety in use and is also competitive from a merely economical standpoint.

This aim and these and other objects that will become better apparent hereinafter are achieved by a sheet-like element with customizing elements, highlighting elements, reflective elements, lettering, characters and the like, particularly for building-yard use and for delimiting spaces, according to the invention, which comprises a sheet-like element made of plastics that is longitudinally elongated, characterized in that it comprises a tape provided with graphic markings, characters, designs, reflective elements and the like that is monolithically associated with said sheet-like body.

### BRIEF DESCRIPTION OF THE DRAWINGS

Further characteristics and advantages of the invention will become better apparent from the description of a preferred but not exclusive embodiment of a sheet-like element with customizing elements, highlighting elements, reflective elements, lettering, characters and the like, particularly for building-yard use and for delimiting spaces, illustrated by way of nonlimiting example in the accompanying drawings, wherein:

FIG. 1 is a schematic view of the sheet-like element according to the invention, with the tape arranged at an edge;

FIG. 2 is a view of a sheet-like element with the tape arranged in a central region;

FIG. 3 is a schematic sectional view, taken along the line III-III of FIG. 1;

FIG. 4 is a view of the step of application of the tape during extrusion of the sheet-like body;

FIG. 5 is a view of a mono-oriented sheet-like element;

FIG. 6 is a view of a biaxially-oriented sheet-like element.

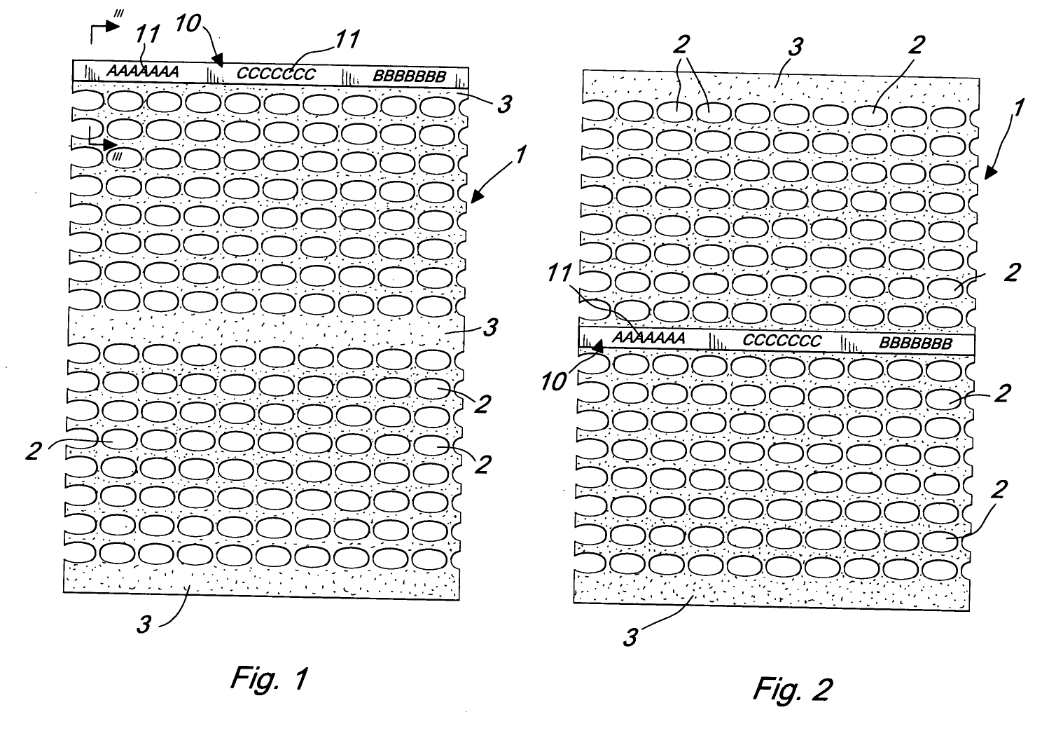

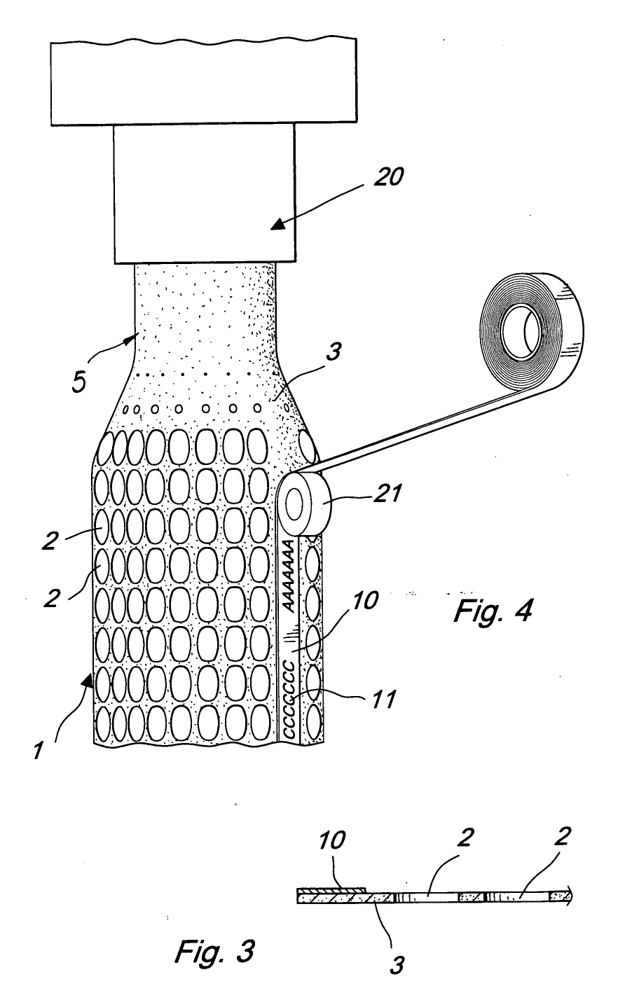

### DESCRIPTION OF THE PREFERRED EMBODIMENTS

With reference to the figures, the sheet-like element with customizing elements, highlighting elements, reflective elements, lettering, characters and the like comprises a sheet-like body 1, which is advantageously made of plastic material such as polyethylene, polypropylene and the like, which has a plurality of openings 2 so as to provide a classic net for delimiting spaces.

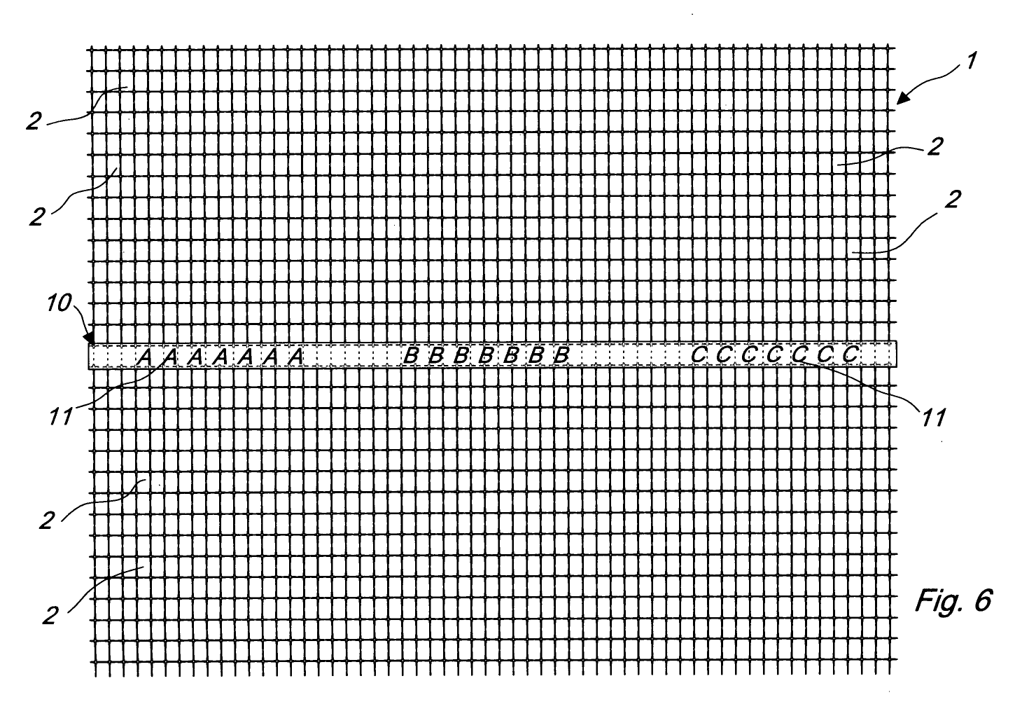

The net can be of any kind and can be mono-oriented or biaxially-oriented, as shown in FIGS. 5 and 6.

Advantageously, on the sheet-like body 1 it is possible to provide bands or strips 3 where the sheet-like body is continuous.

The particularity of the invention consists in that a tape 10 is provided monolithically on the longitudinally elongated sheet-like body 1; such tape is provided with lettering, characters, designs, reflective elements, customization elements and so forth, generally designated by the reference numeral 11, which are provided directly on the tape, which is then coupled monolithically to the sheet-like body 1, preferably at the continuous bands or strips 3, if they are present.

The tape 10 can be applied by adhesive bonding or thermal bonding and can also be applied directly during extrusion of the sheet-like body.

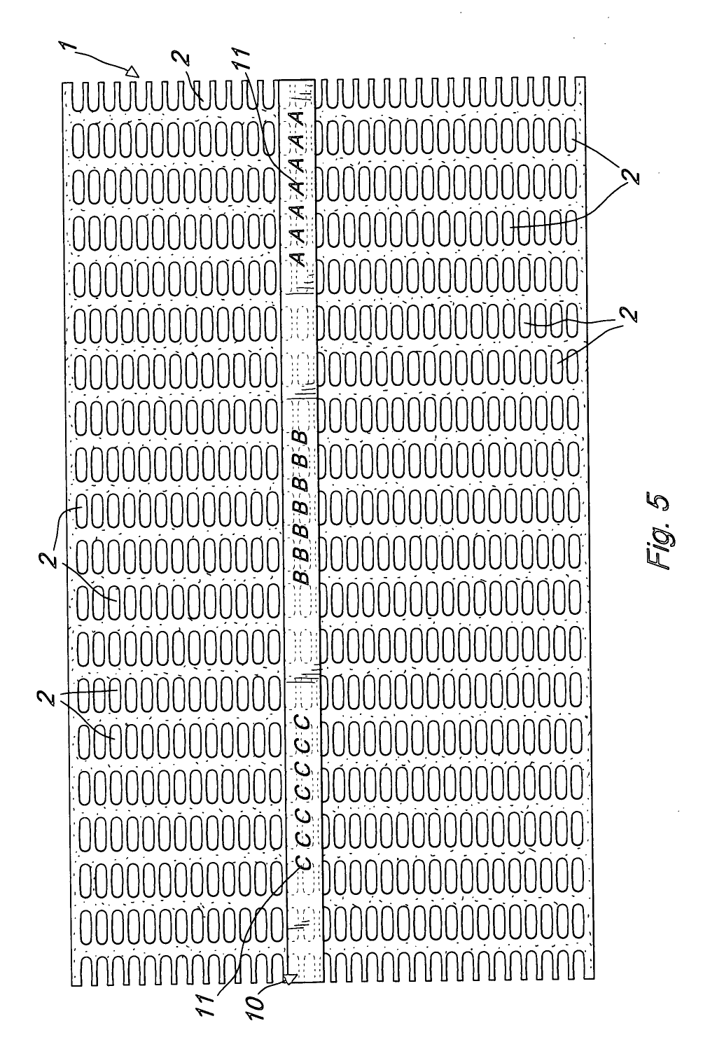

As shown schematically in. FIG. 4, it is possible to provide, directly downstream of the extrusion head 20, extruding a plastics, tubular element 5 with a plurality of through openings 2, an applicator 21 that applies by pressing the tape 10 to the still-warm plastic material, and it is therefore possible to achieve an intimate bonding especially if the same materials or otherwise chemically compatible materials are used for the sheet-like body and for the tape eventually obtained by longitudinal cutting of the tubular element 5.

The possibility to apply the tape directly at extrusion time allows to obtain a monolithic assembly, providing in practice a sheet-like element in which the lettering, indications and anything else deemed appropriate is already embedded.

From the above description it is therefore evident that the invention achieves the intended aim and objects, and in particular the fact is stressed that a sheet-like element for delimiting spaces, such as a plastic net, is provided which allows to embed directly therein lettering, characters and the like without having to resort to printing operations that are practically impossible to perform on the manufactured sheet-like element.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements.

The disclosures in Italian Patent Application No. MI2002A002474 from which this application claims priority are incorporated herein by reference.

What is claimed is:

1. A sheet element with customizing elements for building-yard use and for delimiting spaces, comprising: a sheet body made of plastics that is longitudinally elongated and a tape provided with graphic markings, characters, designs and/or reflective elements that is monolithically associated with said sheet-shaped body.

2. The sheet element of claim 1, wherein said sheet-shaped body is mono-oriented.

3. The sheet element of claim 1, wherein said sheet-shaped body is biaxially oriented.

4. The sheet element of claim 1, wherein said sheet-shaped body comprises a plurality of through openings and at least one continuous band that runs longitudinally on said sheet-shaped body.

5. The sheet element of claim 4, wherein said tape is arranged at said continuous band.

6. The sheet element of claim 5, wherein said tape is connected to said sheet-shaped body by thermal bonding.

7. The sheet element of claim 5, wherein said tape is connected to said sheet-shaped body by adhesive bonding.

8. The sheet element of claim 5, wherein said tape is embedded in said sheet-shaped body.

9. A method for manufacturing a sheet element with customizing elements, as set forth in claim 4, comprising the steps of: extruding through an extrusion head a tubular element made of plastics; providing said tubular element with through holes therein; applying by pressure on said tubular element, directly downstream of the extrusion head, a tape provided with graphical markings, characters, designs, and/or reflective elements; cooling said tubular element; and obtaining, by longitudinal cutting, a longitudinally elongated sheet-shaped body.

10. The method of claim 9, comprising making said tape and said sheet-shaped body of chemically compatible plastic materials.

11. The method of claim 9, wherein said tape and said sheet-shaped body are made of a same plastic material.
